(19) United States
(12) Patent Application Publication
(10) Pub. No.: US 2021/0182739 A1
(43) Pub. Date: Jun. 17, 2021

(54) ENSEMBLE LEARNING MODEL TO IDENTIFY CONDITIONS OF ELECTRONIC DEVICES

(71) Applicant: Toyota Motor Engineering & Manufacturing North America, Inc., Erlanger, KY (US)

(72) Inventor: Muhamed Farooq, Dearborn, MI (US)

(73) Assignee: Toyota Motor Engineering & Manufacturing North America, Inc., Erlanger, KY (US)

(21) Appl. No.: 16/717,640

(22) Filed: Dec. 17, 2019

(51) Int. Cl. G06N 20/20; G07C 5/08; G06N 5/00; G06N 5/04; G05D 1/02

(52) U.S. Cl. CPC G06N 20/20; G07C 5/085; G05D 1/0221; G06N 5/04; G06N 5/003

(57) ABSTRACT

Apparatuses, systems, and methods execute an iterative training process that executes an iterative training process to train an Ensemble Learning Model based on a plurality of observations associated with electronic devices so that the Ensemble Learning Model predicts conditions of the electronic devices. The electronic devices are associated with a vehicle. The iterative training process includes iteratively training the Ensemble Learning Model based on different groups of the plurality of observations during different iterations, wherein the different groups of the plurality of observations are associated with different subsets of the electronic devices, and generating an Out-of-Bag score based on whether the Ensemble Learning Model correctly predicts conditions of the electronic devices based on observations of the plurality of observations that were previously unutilized to train the Ensemble Learning Model. The apparatuses, systems, and methods further determine whether to propagate the Ensemble Learning Model to vehicles based at least in part on the Out-of-Bag score.

### TECHNICAL FIELD

Embodiments generally relate to an Ensemble Learning Model that identifies conditions of electronic devices of a vehicle. More particularly, embodiments relate to a generation of an Ensemble Learning Model and implementation of the Ensemble Learning Model.

### BACKGROUND

Electronic devices (e.g., power electronic devices such as transistors, diodes and Insulated Gate Bipolar Transistors) in vehicles (e.g., fully-electric vehicles) may be exposed to extreme operating conditions such as thermal stress and/or electrical stress. Some vehicles may not be able to accurately detect current conditions of such electronic devices and/or predict future conditions of the electronic devices. For example, some vehicles may be unable to detect conditions of the electronic devices since sensor data of the electronic devices may have noisy and nonlinear properties. In such vehicles, when the electronic devices fail the vehicles may result in inconvenience for the operator, and in some cases lead to difficult operating conditions for the operator reducing safety and efficiency.

### BRIEF SUMMARY

In some embodiments a computing device includes an observation data storage to store a plurality of observations associated with electronic devices associated with a vehicle and a training system. The training system includes at least one processor and at least one memory having a set of instructions, which when executed by the at least one processor, cause the training system to execute an iterative training process to train an Ensemble Learning Model to predict conditions of the electronic devices, wherein the iterative training process includes iteratively training the Ensemble Learning Model based on different groups of the plurality of observations during different iterations, wherein the different groups of the plurality of observations are associated with different subsets of the electronic devices, and generating an Out-of-Bag score based on whether the Ensemble Learning Model correctly predicts conditions of the electronic devices based on observations of the plurality of observations that were previously unutilized to train the Ensemble Learning Model. The training system further determines whether to propagate the Ensemble Learning Model to vehicles based at least in part on the Out-of-Bag score.

In some embodiments, at least one computer readable storage medium comprises a set of instructions, which when executed by a computing device, cause the computing device to execute an iterative training process to train an Ensemble Learning Model based on a plurality of observations associated with electronic devices so that the Ensemble Learning Model predicts conditions of the electronic devices. The electronic devices are associated with a vehicle. The iterative training process includes iteratively training the Ensemble Learning Model based on different groups of the plurality of observations during different iterations, wherein the different groups of the plurality of observations are associated with different subsets of the electronic devices, and generating an Out-of-Bag score based on whether the Ensemble Learning Model correctly predicts conditions of the electronic devices based on observations of the plurality of observations that were previously unutilized to train the Ensemble Learning Model. The instructions, when executed, cause the computing device to determine whether to propagate the Ensemble Learning Model to vehicles based at least in part on the Out-of-Bag score.

In some embodiments, a method includes executing an iterative training process to train an Ensemble Learning Model based on a plurality of observations associated with electronic devices so that the Ensemble Learning Model predicts conditions of the electronic devices, wherein the electronic devices are associated with a vehicle. The iterative training process includes iteratively training the Ensemble Learning Model based on different groups of the plurality of observations during different iterations, wherein the different groups of the plurality of observations are associated with different subsets of the electronic devices, and generating an Out-of-Bag score based on whether the Ensemble Learning Model correctly predicts conditions of the electronic devices based on observations of the plurality of observations that were previously unutilized to train the Ensemble Learning Model. The method further includes determining whether to propagate the Ensemble Learning Model to vehicles based at least in part on the Out-of-Bag score.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a diagram of an example of a Random Forest Classifier generation and implementation scenario according to an embodiment;

FIG. 2 is a block diagram of an example of a training system according to an embodiment;

FIG. 3 is a flowchart of an example of a method of Random Forest Classifier generation and propagation according to an embodiment;

FIG. 4 is a diagram of an example of a scenario in which a vehicle implements an unsupervised degradation detection algorithm and Random Forest Classifier according to an embodiment;

FIG. 5 is a block diagram of an example of a vehicle that implements a Random Forest Classifier according to an embodiment;

FIG. 6 is a flowchart of an example of a method of identifying conditions of a vehicle based on a Random Forest Classifier according to an embodiment; and

FIG. 7 is a flowchart of an example of a method of executing an action based on a failure prediction of an electronic device according to an embodiment.

### DETAILED DESCRIPTION

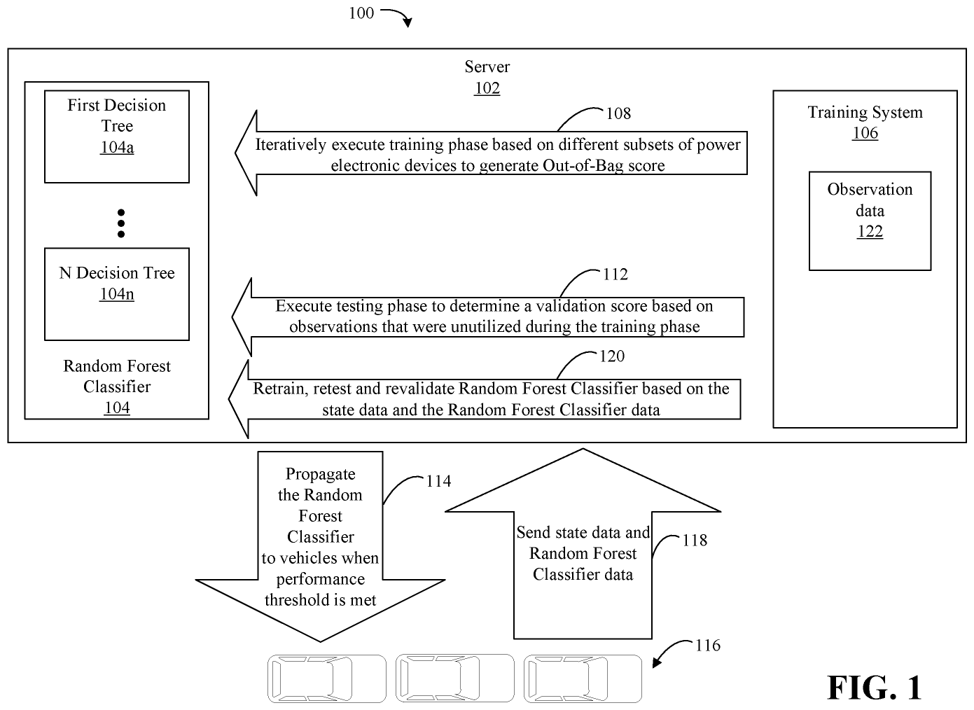

Turning now to FIG. 1, a Random Forest Classifier 104 training and deployment process 100 is illustrated. While a Random Forest Classifier 104 is specifically illustrated and discussed below, it will be understood that other types of Ensemble Learning Models may be similarly trained, tested, validated and propagated as described below where applicable. A server 102 may be a cloud-based system that is in communication with vehicles 116. The server 102 may generate, iteratively train, test and validate the Random Forest Classifier 104 based on observation data 122 that is associated with electronic devices (e.g., transistors, diodes, Insulated Gate Bipolar Transistors etc.). The electronic devices, when provided inside a vehicle, may control systems of the vehicle and/or power to the systems.

The Random Forest Classifier 104 may be trained to detect various conditions of the electronic devices. For example, the Random Forest Classifier 104 may be trained to detect conditions such as an operating condition of an electronic device. The remaining useful life of the electronic device may be estimated using an algorithm (e.g., Kalman Filters or Regression) associated with the Random Forest Classifier 104 that may be triggered after the Random Forest Classifier 104 detects a high-interest condition. The algorithm may be triggered when the random forest classifier 104 detects a high interest condition. Thus, when implemented in a vehicle, the Random Forest Classifier 104 may be able to detect a condition of each of the electronic devices of the vehicle, trigger an algorithm to determine a remaining life of the electronic device and the vehicle may be able to execute appropriate actions (e.g., warn a user, reroute power to bypass a failing electronic device, shut-down a system that includes the electronic device to avoid damage, move vehicle to safe location and/or disallow one or more functions such as acceleration, movement, etc. of the vehicle, take the vehicle to a repair shop for repair) based on the detected conditions. The above process 100 may model characteristics of the electronic devices despite noisy and nonlinear properties of sensor data that is used as part of the observation data 122. Other designs may be unable to accurately detect conditions of the electronic devices due to the noisy and nonlinear properties discussed above.

That is, the Random Forest Classifier 104 may model degradation behavior of an electronic device to identify how the electronic device deviates from a normal and/or healthy state to ultimately a failure state. The Random Forest Classifier 104 may determine when the electronic device is starting to fail (e.g., detect a high-interest condition) before the electronic device actually fails (e.g., the electronic device crosses a certain performance threshold indicating failure may occur). For example, the Random Forest Classifier 104 may identify a high-interest condition that corresponds to imminent failure in an electronic device a hundred power cycles (or 100 hours) or more of the electronic device before failure. As discussed above, an algorithm associated with the Random Forest Classifier 104 may estimate the remaining useful life.

That is, the Random Forest Classifier 104 may determine that an electronic device is unhealthy but not yet failed, to predict future failure conditions of the electronic device so that the vehicle and/or user of the vehicle may execute proactive mitigation procedures prior to the failure. For example, the user may be directed to a repair facility to repair the failing electronic device prior to the failing electronic device actually failing.

The server 102 may communicate with vehicles 116 and receive state data that may be used as part of the observation data 122. Thus, the performance of the Random Forest Classifier 104 may be enhanced with observations (e.g., sensor data and identifications of conditions of the electronic devices that correspond to time periods when the sensor data is sensed) that correspond to “live” implementations of the Random Forest Classifier 104. Moreover, the process 100 may provide two different testing scores (e.g., Out-of-Bag score and validation score) to confirm the effectiveness of the constructed Random Forest Classifier 104. Doing so may reduce the potential of a poorly performing model being released. In some embodiments, only one testing score may be utilized.

As illustrated, the training system 106 may include the observation data 122 (e.g., a data set). The observation data 122 may include sensor data and labels (e.g., conditions such as failure or healthy) of the sensor data. For example, the server 102 (or other computing device) may generate the observation data 122 through stressing the electronic devices electrically and/or thermally over a period of time through various stressors. For example, an electronic device may be subjected to repeated switching (e.g., turning ON and OFF the electronic device), increased power flows, temperature stressing and so on. For example, if the electronic devices are Insulated Gate Bipolar Transistors (IGBTs), the IGBTs may turn on for a predetermined amount of seconds (e.g., roughly corresponding to 10 kHz), over a series of cycles (e.g., 200,000 cycles) and determine when the IGBTs begin to fail. The observation data 122 may include sensor data of the electronic devices during the stressing, and labels (e.g., failure, begins to degrade, failure imminent) that were observed during the stressing.

As such, each observation of the observation data 122 may include sensor data and a label of an electronic device. The sensor data may include direct sensor measurements (e.g., voltage output, current output, temperature, etc.) of the electronic device. The label may be the condition of the electronic device when the sensor measurements are measured. Thus, different observations may correspond to sensor data and labels that are measured at different times.

The server 102 may iteratively execute a training phase based on different subsets of power electronic devices to generate an Out-of-Bag score 108. As illustrated, the Random Forest Classifier 104 may include first-N decision trees 104a-104n (e.g., 100 estimators) operating as an ensemble. The first-N decision trees 104a-104n may be trained iteratively on a dataset of the observation data 122. The first-N decision trees 104a-104n may be diversified in that the first-N decision trees 104a-104n may determine decisions based on different inputs. For example, the first decision tree 104a may form a decision based on a first group of inputs while the N decision tree 104n may form a decision based on a second group of inputs different from the first group. By determining decisions based on different inputs, the first-N decision trees 104a-104n may be uncorrelated and diversified to avoid overfitting.

Each iteration of the iterative training phase may involve training on data of the observation data 122 associated with a subset of the electronic devices while some of the observation data 122 may be excluded for generating an Out-of-Bag score. It is worthwhile to note that the subset of the electronic devices may change between iterations.

For example, suppose that there are seven electronic devices. A first iteration may train on data from the observation data 122 from a first time that is associated with the first-fifth electronic devices (e.g., the subset of electronic devices) and exclude data from the observation data 122 that is associated with the sixth and seventh electronic devices at the first time. A second iteration may train on data from the observation data 122 that is associated with the first, second, third, fourth, sixth and seventh electronic devices at a second time and exclude data from the observation data 122 that is associated with the fifth electronic device at the second time. Thus, while each iteration may train on data from the observation data 122 that was observed at approximately a same time, some of the data from the observation data 122 that was observed at approximately the same time be excluded as testing data.

Concurrently with the above and during the training phase, the training system 106 may generate Out-of-Bag (OOB) scores. For example, and as noted above, each iteration of the training phase may train only on a subset of the observation data 122 that is observed at a same time, while another portion of the observation data 122 that is observed at the same time may be excluded. The Random Forest Classifier 104 may be semi-tested based on the excluded data. For example, if the Random Forest Classifier 104 correctly identifies a condition (as identified by a label of sensor data) based on the sensor data, then the server 102 may record that the Random Forest Classifier 104 executed correctly to generate an overall accuracy score (e.g., average accuracy of all semi-testings over the iterations of the training phase to generate the OOB score). The OOB score may be a percentage of correctly identified conditions.

For example, the Out-Of-Bag score may be obtained during the training phase. Suppose during the training phrase there is a dataset associated with 5 devices. For each device, the dataset may include 1,000 observations making a total of 5,000 observations. From those 5,000 samples, the training system 106 may choose a sub-sample (e.g. 200 samples) to semi-test while training to generate the OOB score during the iterations.

That is, each of first-N decision trees 104a-104n predicts the electronic devices' conditions and/or states (e.g., failed, failure may occur within a usage period or no failure within usage period, seems to be degrading in utility, not failed etc.) and the state with the most votes becomes the prediction of the Random Forest Classifier 104. Thus, the Random Forest Classifier 104 may predict the conditions of the electronic devices based on a majority vote of the first-N decision trees 104a-104n. If the state is of high-interest (e.g., failure may occur), another algorithm may then predict a remaining useful life.

The training system 106 may further execute a testing phase to determine a validation score based on observations that were unutilized during the training phase 112. For example, a portion of the observation data 122 may be reserved from the training phase. The portion of the observation data 122 may include all observations from various time periods. Thus, the training phase may operate on all observations from a first subset of time periods, while the testing phase may include generating a validation score based on unseen observations from a second subset of the time periods. The validation score (e.g., a percentage of correct answers) may be determined during the testing phrase based on whether the Random Forest Classifier 104 correctly identifies conditions of the electronic devices based on the observations from the second subset of the time periods (e.g., unseen observations). The testing phase may evaluate the Random Forest Classifier's performance before implementation to execute on presumably future (unseen) observations.

The performance of the Random Forest Classifier 104 may be evaluated based on the validation score and the OOB score. For example, if the validation score and the OOB score both meet thresholds respectively, the training system 106 may determine that the Random Forest Classifier 104 is reliable and within acceptable limits to be propagated. Additionally, if the validation score and the OOB score are within a predetermined amount of each other, the training system 106 may deem that the Random Forest Classifier 104 may be propagated. If the validation score and the OOB score are outside of the predetermined amount from each other, the Training System 106 may determine that the Random Forest Classifier 104 may not consistently identify device conditions and require retraining to better fit a phenomenon that may be present in the observation data 122. In some embodiments, the OOB score may be used to determine whether to propagate the Random Forest Classifier 104 and the validation score need not be utilized.

The server 102 may propagate the Random Forest Classifier 104 to vehicles 116 when a performance threshold is met 114. For example, the performance threshold may be met when the validation score and the OOB score are within a predetermined amount of each other and/or the validation score and the OOB score are above thresholds respectively. In some embodiments, only one of the validations scores and OOB scores may be considered to determine whether the Random Forest Classifier 104 meets the performance threshold.

In some embodiments, the performance threshold may further include identifying that the Random Forest Classifier 104 is applicable each of the vehicles 116. For example, the server 102 may determine whether the observation data 122 corresponds (e.g., originates from) to vehicles that are the same or similar to vehicles 116. If not, the Random Forest Classifier 104 may not accurately detect conditions of the vehicles 116 since the Random Forest Classifier 104 was trained on a data set that does not correspond to the vehicles 116. If the observation data 122 does correspond to vehicles that are the same or similar to vehicles 116, the Random Forest Classifier 104 may be deemed to be applicable to the vehicles 116. In some embodiments, the server 102 may identify whether the observation data 122 originates from systems (e.g., power steering, actuation control, autonomous driving systems, Power Cards (IGBTs) in the Power Control Unit (PCU)) that are identical (or sufficiently similar to) systems of the vehicles and deem the Random Forest Classifier 104 to be applicable to the vehicles 116 if so. Thus, when the Random Forest Classifier 104 is applicable to the vehicles 116, the server 102 may determine that the performance threshold is met. Thus, the performance threshold may be met when one or more of the above conditions are met.

The vehicles 116 may receive the Random Forest Classifier 104 from the server 102. The server 102 may transmit the Random Forest Classifier 104 over a wireless medium, such as the internet. The vehicles 116 implement the Random Forest Classifier 104 on each of the vehicles 116 to identify conditions of electronic devices of the vehicles 116. During execution of the Random Forest Classifier 104, the vehicles 116 may track state data and Random Forest Classifier Data.

The state data may include sensed data of the vehicles 116 during execution of the Random Forest Classifier 104. The state data may further include an indication of whether an electronic device failed or remained healthy (not in a fail state) during generation of the sensed data.

The Random Forest Classifier data may include predictions of the Random Forest Classifier 104 based on the sensed data. For example, the Random Forest Classifier 104 may form the predictions based on the sensed data to predict conditions of the electronic devices (e.g., whether electronic devices are healthy, failed and/or degrading). Thus, the Random Forest Classifier data may include future predictions of whether the electronic devices will fail or will not fail in the future based on currently sensed conditions.

In contrast, the sensed data may not include such future predictions but may instead track currently whether an electronic device is failed or not failed. Therefore, the accuracy of conditions by the Random Forest Classifier 104 may be determined by comparing the conditions to the sensed data to determine whether the electronic devices fail or not fail as predicted by the Random Forest Classifier 104.

For example, suppose that the Random Forest Classifier 104 predicts that an electronic device is in a high interest condition that corresponds to a device failing in 100 cycles and/or hours. The prediction by the Random Forest Classifier 104 may be verified against the sensed data to determine whether the sensed data indicates the electronic device indeed did fail 100 cycles and/or hours later.

If the predictions align (e.g., predicted a failure after 100 cycles and the sensed data shows a failure occurred at around 100 cycles later), the Random Forest Classifier 104 may be deemed to be working correctly. If however the Random Forest Classifier data does not align with the state data (e.g., did not predict failure after 100 cycles and sensed data indicates the failure did occur after 100 cycles), the Random Classifier 104 may be readjusted.

The state data may include sensor data of the electronic devices, a condition (e.g., failed or healthy) of the electronic devices and so forth. For example, the sensor data may include data associated with the electronic devices that the Random Forest Classifier 104 may utilize to generate an identification of the condition of the electronic devices. The sensor data may further include a condition of the electronic devices. That is, the sensor data may include whether an electronic device failed, remained healthy, degraded in health, etc. as well as sensed conditions of the electronic devices. The state data may include Collector-Emitter Current, Collector-Emitter Voltage, Drain Voltage, Drain-to-Source Voltage, Gate Voltage and/or Junction Temperature. The vehicles 116 may collectively or individually send the state data and Random Forest Classifier 104 data 118 to the server 102. The Random Forest Classifier 104 data may include an indication of a predicted condition of the electronic devices as predicted by the Random Forest Classifier.

The training system 106 may identify whether retraining should be executed based on the state data. For example, if a comparison of the state data to the Random Forest Classifier data identifies that the Random Forest Classifier 104 did not accurately predict a certain percentage of conditions and/or predicted false conditions (e.g., provided inaccurate predictions of failures or healthy states), the training system 106 may determine that retraining should be executed. Otherwise, retraining may not be necessary. In some embodiments, the state data may include a series of data input and observations over time that may be used to enhance training.

In some embodiments, the training system 106 may determine, from the state data, a number of inaccurate predictions by the Random Forest Classifier 104 of one or more conditions of the electronic devices of the vehicles 116. The training system 106 may conduct a comparison of the number to an adjustment threshold and determine that the Random Forest Classifier should be adjusted based on the comparison and when the number meets the adjustment threshold.

In some embodiments, training system 106 may determine that retraining should be executed when the state data includes a new set of circumstances (e.g., unseen data associated with unique situations) and a resulting condition that is not identified or encompassed by the observation data 122. For example, suppose that the observation data 122 includes observations that were measured at a particular temperature range. The training system 106 may determine that retraining should be executed when the sensor data includes condition and sensor data associated with temperatures outside the temperature range.

In this particular example, the training system 106 may determine that retraining should be executed, and may retrain, retest and revalidate the Random Forest Classifier 104 based on the state data and Random Forest Classifier data 120 to train on new unseen data from the vehicles 116, and similarly to as described above with respect to the training phase, testing phase and validation score generation. That is the aforementioned features may repeat based on the sensor data (e.g., the sensor data may be used as observation data to train the random forest classifier 104), and the modified Random Forest Classifier 104 may be propagated to the vehicles when the performance threshold is met. The vehicles may then implement the modified Random Forest Classifier 104 and the process 100 may repeat. In doing so, the Random Forest Classifier 104 may be adjusted to be more robust and responsive to real-world driving circumstances and usages.

It is worthwhile to note that the server 102 may take various implementations without modifying the scope of the aforementioned discussion. For example, the server 102 may be a mobile device, computing device, tablet, laptop, desktop etc.

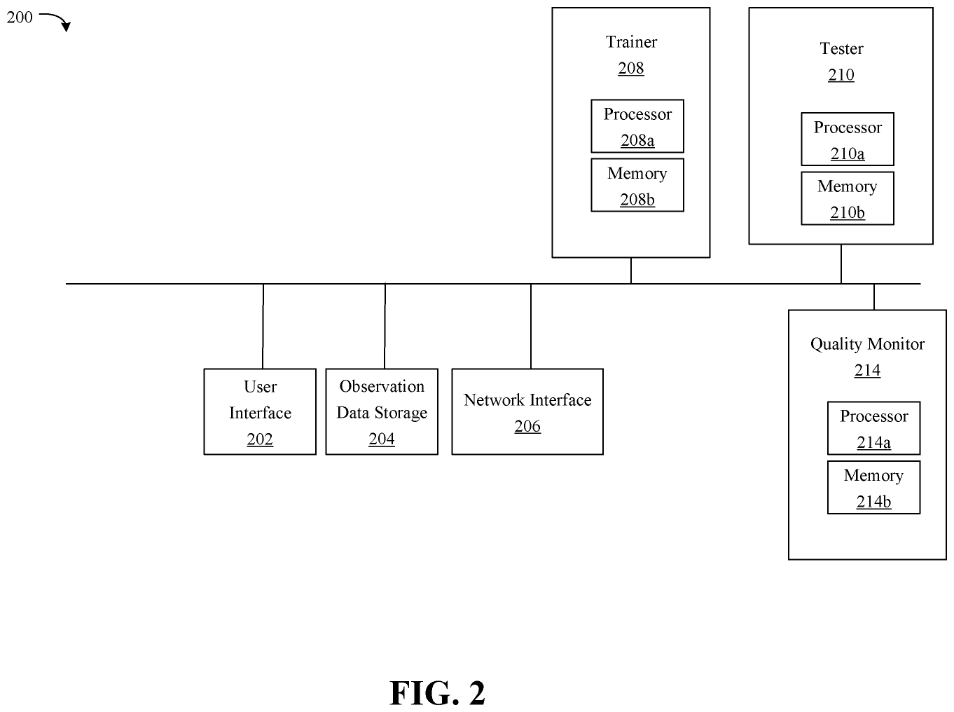

FIG. 2 shows a more detailed example of a training system 200 of a computing device to generate, train and implement a Random Forest Classifier. The illustrated training system 200 may be readily implemented in server 102 to execute process 100 (FIG. 1) and may implement any of the other methods and/or processes discussed herein.

In the illustrated example, the training system 200 may include a network interface 206. The network interface 206 may allow for communications between training system 200, computing devices and vehicles. The network interface 206 may operate over various wireless and/or wired communications. The training system 200 may include an observation data storage 204 that stores observation data as described herein. The training system 200 may further include a user interface 202 that allows a user to interface with the training system 200 and view results (e.g., Random Forest Classifier, validation scores, OOB scores, etc.).

The training system 200 may include a trainer 208 to generate and train a Random Forest Classifier based on the observation data stored in the observation data storage 204. The trainer 208 may train the Random Forest Classifier in an iterative process. The training system 200 may include a tester 210. The tester 210 may test the Random Forest Classifier based on the observation data. The validator 212 may generate a validation score for the Random Forest Classifier based on observation data that was excluded from the training phase. A quality monitor 214 may determine whether the Random Forest Classifier meets a performance threshold and may be propagated to vehicles via the network interface 206. The quality monitor 214 may further determine that the Random Forest Classifier should be retrained when a gap exists between validation scores and out-of-bag scores (e.g., a difference is significant), both the validation scores and out-of-bag scores are low (e.g., below a threshold) and/or based on a comparison of state data to Random Forest Classifier data that is transmitted by the vehicles based on the Random Forest Classifier. In some embodiments, the Random Forest Classifier may be retrained based on the state data and the Random Forest Classifier Data.

Additionally, the trainer 208 may include a processor 208a (e.g., embedded controller, central processing unit/CPU, circuitry, etc.) and a memory 208b (e.g., non-volatile memory/NVM and/or volatile memory) containing a set of instructions, which when executed by the processor 208a, cause the trainer 208 to train the Random Forest Classifier as described herein.

Additionally, tester 210 may include a processor 210a (e.g., embedded controller, central processing unit/CPU, circuitry, etc.) and a memory 210b (e.g., non-volatile memory/NVM and/or volatile memory) containing a set of instructions, which when executed by the processor 210a, cause the tester 210 to test the Random Forest Classifier as described herein to generate a validation score.

Moreover, the quality monitor 214 may include a processor 214a (e.g., embedded controller, central processing unit/CPU, circuitry, etc.) and a memory 214b (e.g., non-volatile memory/NVM and/or volatile memory) containing a set of instructions, which when executed by the processor 214a, cause the quality monitor to propagate and/or retrain the Random Forest Classifier as described herein.

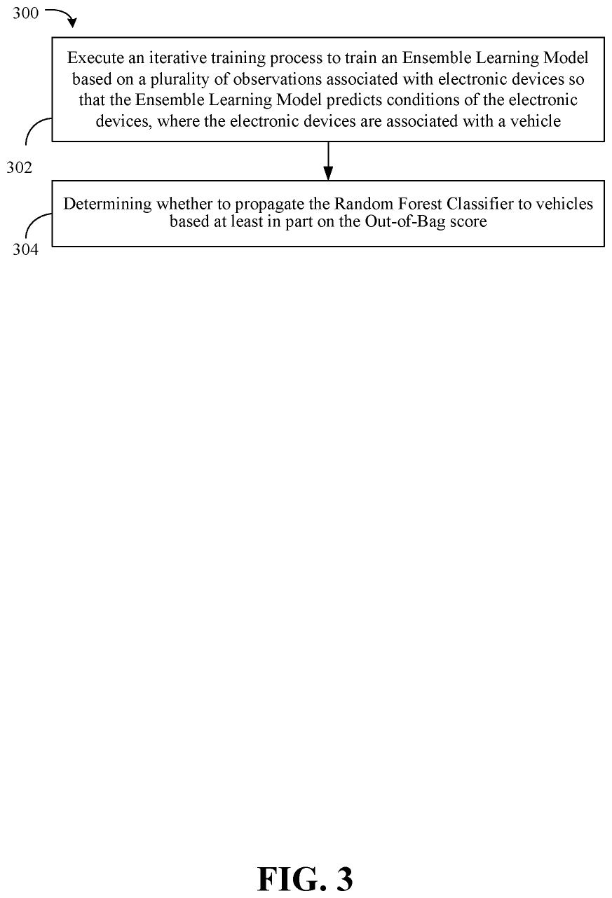

FIG. 3 shows a method 300 of generating and implementing an Ensemble Learning Model (e.g., Random Forest Classifier). The method 300 may generally be implemented in conjunction with any of the embodiments described herein, for example the process 100 of FIG. 1 and/or the system 200 of FIG. 2. In an embodiment, the method 300 is implemented in logic instructions (e.g., software), configurable logic, fixed-functionality hardware logic, circuitry, etc., or any combination thereof.

Illustrated processing block 302 executes an iterative training process to train an Ensemble Learning Model based on a plurality of observations associated with electronic devices so that the Ensemble Learning Model predicts conditions of the electronic devices. The electronic devices are associated with a vehicle. For example, the iterative training process includes iteratively training the Ensemble Learning Model based on different groups of the plurality of observations during different iterations, where the different groups of the plurality of observations are associated with different subsets of the electronic devices, and generating an Out-of-Bag score based on whether the Ensemble Learning Model correctly predicts conditions of the electronic devices based on observations of the plurality of observations that were previously unutilized to train the Ensemble Learning Model. Illustrated processing block 304 determines whether to propagate the Random Forest Classifier to vehicles based at least in part on the Out-of-Bag score.

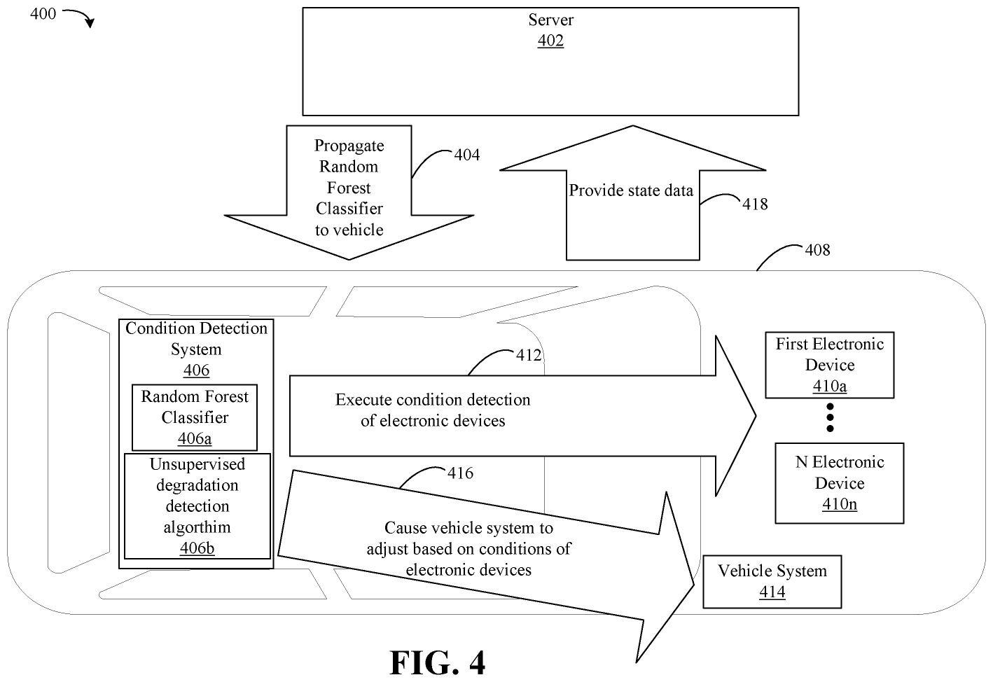

FIG. 4 illustrates a process 400 in which a vehicle 408 identifies conditions of electronic devices based on a Random Forest Classifier 406a. A server 402 may generate, train, validate and propagate the Random Forest Classifier 406a to the vehicle 404, 408. The vehicle 408 may include a condition detection system 406. The condition detection system 406 may implement the Random Forest Classifier 406a and an unsupervised degradation detection algorithm 406b. The unsupervised degradation detection algorithm 406b may differ from the Random Forest Classifier 406b. For example, the Random Forest Classifier 406a may be generated through a supervised approach, while the unsupervised degradation detection algorithm 406b may be generated through an unsupervised approach for example on the server 402. The unsupervised degradation detection algorithm 406b may detect conditions of electronic devices such as the first-N electronic devices 410a-410n.

The condition detection system 406 may execute condition detection of electronic devices 410a-410n, 412. For example, the condition detection system 406 may determine a condition that corresponds to whether any of the first-N electronic devices 410a-410n are going to fail within a certain usage frame (e.g., a time frame, number of power cycles, etc.). The condition detection system 406 may employ both of the unsupervised degradation detection algorithm 406b and the Random Forest Classifier 406a to identify when one electronic device of the first-N electronic devices 410a-410n may fail within the usage frame.

In some embodiments, the condition detection system 406 may automatically determine that the one electronic device will fail when both of the unsupervised degradation detection algorithm 406b and the Random Forest Classifier 406a identify that the one electronic device is in a particular condition (e.g., a condition that corresponds to failure).

In some embodiments, when a disagreement exists between the unsupervised degradation detection algorithm 406b and the Random Forest Classifier 406a, the condition detection system 406 may continue to monitor the one electronic device for a period of time (e.g., one day) before acting to avoid acting on false positives. For example, if the unsupervised degradation detection algorithm 406b determines that the one electronic device is in a condition that corresponds to the electronic device failing within the usage frame, but the Random Forest Classifier 406a determines that the one electronic device is in a healthy condition and therefore will not fail within the usage frame, the condition detection system 406 may continue to monitor the one electronic device before acting.

Before the period of time has elapsed, if the Random Forest Classifier 406a and the unsupervised degradation detection algorithm 406b determine that the one electronic device is in a failure condition indicating that the one electronic device will fail, the condition detection system 406 may determine that the one electronic device will fail within the usage frame. For example, the Random Forest Classifier 406a may modify a decision to determine that the one electronic device is in the failure condition, and therefore agree with the unsupervised degradation detection algorithm 406b. In response to the agreement (e.g., simultaneously with or shortly thereafter), the condition detection system 406 may determine that the one electronic device in the failure condition to fail and take appropriate action.

In the alternative, suppose that before the period of time has elapsed, the unsupervised degradation detection algorithm 406b modifies the condition to determine that the one electronic device will not fail within the usage frame. Further, suppose that the Random Forest Classifier 406a still continues to determine that the one electronic device is in a non-failure condition to not fail within the usage frame. In response, the condition detection system 406 may determine that the one electronic device will not fail within the usage frame thereby avoiding acting on a false positive.

If a disagreement still exists when the period of time elapses, the condition detection system 406 may default to the worst-case scenario identified by the Random Forest Classifier 406a or the unsupervised degradation detection algorithm 406b (i.e., that the one electronic device will fail in the usage frame). Thus, the condition detection system 406 may determine that the one electronic device will fail despite the disagreement and act accordingly.

In the present example, the condition detection system 416 may cause one or more vehicle systems 414 to adjust based on conditions of the electronic devices. For example, if the condition detection system determines that one of the electronic devices will fail within the usage frame, a notification system (e.g., audio or visual notifier) may be controlled to provide a warning to a user of the vehicle advising the user to take the vehicle 408 for maintenance. In some embodiments, the life of the one electronic device may be increased by causing a vehicle system of the vehicle system 414 to control states (e.g., reduce power, minimize power, reduce switching) of the one electronic device to prolong the life of the one electronic device.

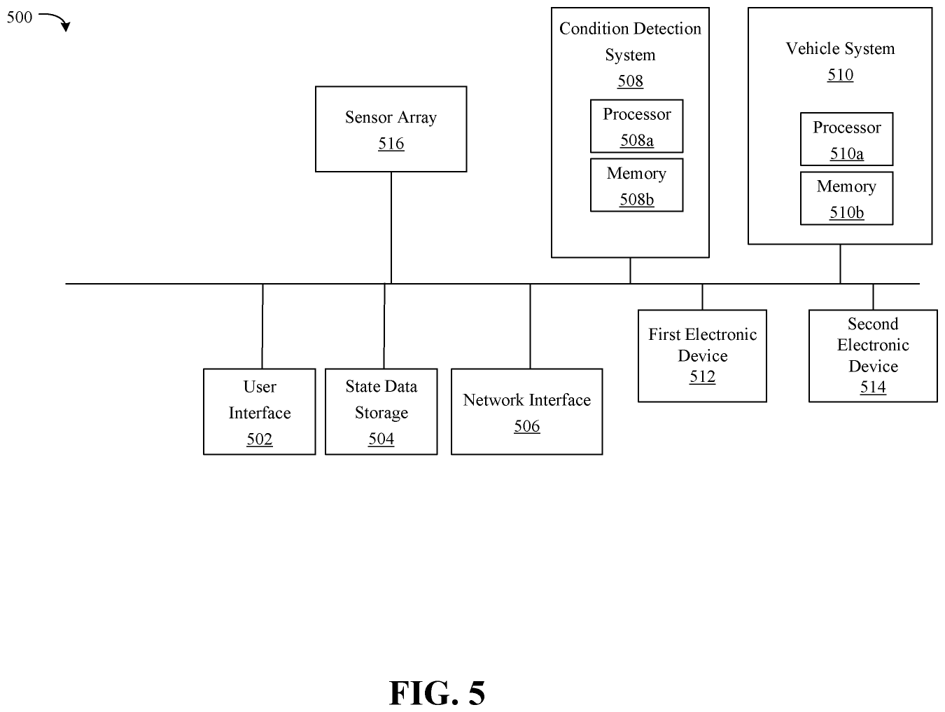

FIG. 5 shows a more detailed example of a vehicle 500 that executes based on an unsupervised degradation detection algorithm and Random Forest Classifier. The illustrated control system 500 may be readily implemented in vehicles 116 to execute process 100 (FIG. 1), the vehicle 408 of FIG. 4 and may implement any of the other methods and/or processes discussed herein.

In the illustrated example, the vehicle 500 may include a network interface 506. The network interface 506 may allow for communications between vehicle 500, computing devices (e.g., servers) and vehicles. The network interface 506 may operate over various wireless and/or wired communications. The vehicle 500 may include a state data storage 504 that stores state data as described herein.

The vehicle 500 may further include a user interface 502 that allows a user to interface with the condition detection system 508 and view results (e.g., conditions of electronic devices, etc.). The vehicle 500 may further include first and second electronic devices 512, 514. The vehicle 500 may further include a sensor array 516 to sense various environmental and operating characteristics of the first and second electronic devices 512, 514 as sensor data.

The vehicle 500 may include the condition detection system 508 to determine conditions of the first and second electronic devices 512, 514 based on the unsupervised degradation detection algorithm and/or Random Forest Classifier. The vehicle 500 may include a vehicle system 510. The vehicle system 510 may include a display, audio, power-on system, etc.

Additionally, the condition detection system 508 may include a processor 508a (e.g., embedded controller, central processing unit/CPU, circuitry, etc.) and a memory 508b (e.g., non-volatile memory/NVM and/or volatile memory) containing a set of instructions, which when executed by the processor 508a, cause the condition detection system 508 to determine conditions of the first and second electronic devices 512, 514 as described herein based on the sensor data from the sensor array 516 as well as the Random Forest Classifier and unsupervised degradation detection algorithm, The instructions, when executed, may further cause the processor 508a to store state data in the state data storage 504.

Additionally, vehicle system 510 may include a processor 510a (e.g., embedded controller, central processing unit/CPU, circuitry, etc.) and a memory 510b (e.g., non-volatile memory/NVM and/or volatile memory) containing a set of instructions, which when executed by the processor 510a, cause the vehicle system 510 to take an action based on the detected conditions of the first and second electronic devices 512, 514 and as described herein.

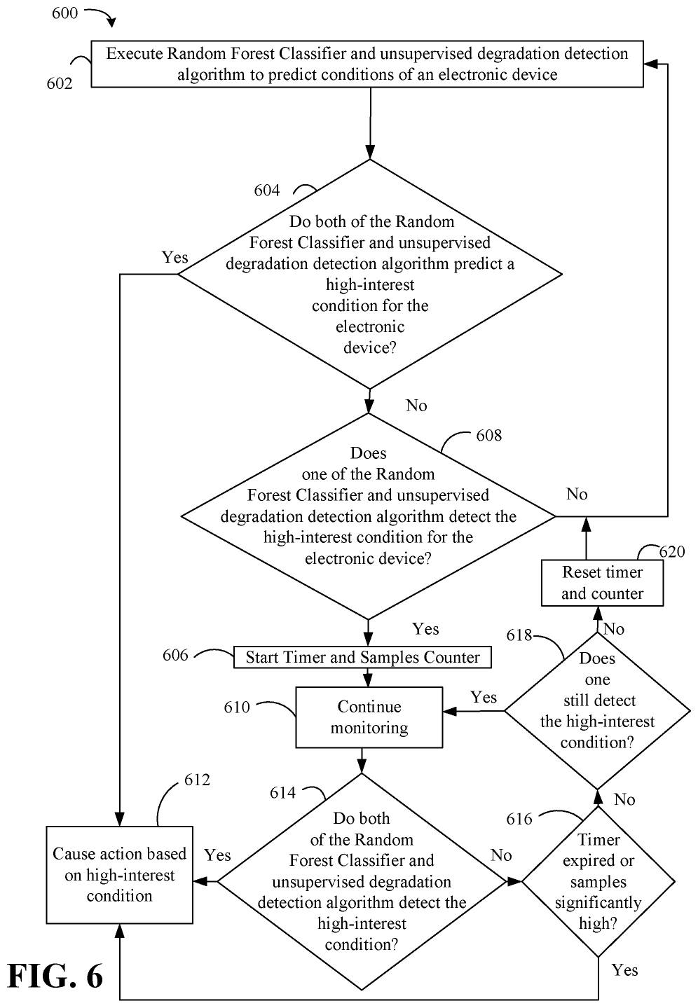

FIG. 6 shows a method 600 of identifying conditions of a vehicle. The method 600 may generally be implemented in conjunction with any of the embodiments described herein, for example the process 100 of FIG. 1, the system 200 of FIG. 2, the method 300 of FIG. 3, the process 400 of FIG. 4 and/or the vehicle 500 of FIG. 5. In an embodiment, the method 600 is implemented in logic instructions (e.g., software), configurable logic, fixed-functionality hardware logic, circuitry, etc., or any combination thereof.

Illustrated processing block 602 executes a Random Forest Classifier and unsupervised degradation detection algorithm to predict conditions of an electronic device. Illustrated processing block 604 determines whether both of the Random Forest Classifier and unsupervised degradation detection algorithm predict a condition (e.g., a high-interest condition) for the electronic device. That is, illustrated processing block 604 determines whether the conditions predicted by the Random Forest Classifier and unsupervised degradation detection algorithm in block 602 are the same, and if any of the conditions are a high-interest condition (e.g., predictive of a failure within a certain usage frame). If so, illustrated processing block 612 causes an action (e.g., notify user, execute proactive measures to reduce load of the electronic device, etc.) based on the high-interest condition.

If both the Random Forest Classifier and unsupervised degradation detection algorithm do not predict the high-interest condition for the electronic device, then illustrated processing block 608 determines if one of the Random Forest Classifier and unsupervised degradation detection algorithm predicts the high-interest condition for the electronic device. If not, illustrated processing block 602 may execute and the method 600 starts over. If one of the of the Random Forest Classifier and unsupervised degradation detection algorithm detects the high-interest condition for the electronic device, illustrated processing block 606 starts a timer and a samples counter to keep track of the number of samples that cross a threshold. Illustrated processing block 610 continues monitoring the electronic device (e.g., gathering sensor data associated with the one electronic device) over a time period. Illustrated processing block 614 determines if both the Random Forest Classifier and the unsupervised degradation detection algorithm detect the high-interest condition based on the monitoring (e.g., gathered sensor data during the time period). If so, illustrated processing block 612 executes.

Otherwise, illustrated processing block 616 determines whether the timer has expired or if the samples are significantly high (e.g., above another threshold). If so, illustrated processing block 612 may execute despite only one of the Random Forest Classifier and the unsupervised degradation detection algorithm predicting that the electronic device has the high-interest condition. If the timer has not expired and the samples are not significantly high, then illustrated processing block 618 determines whether one of the Random Forest Classifier and the unsupervised degradation detection algorithm still detects the high-interest condition. If so, illustrated processing block 610 continues monitoring. Otherwise, illustrated processing block 620 resets the timer and counter and illustrated processing block 602 then executes.

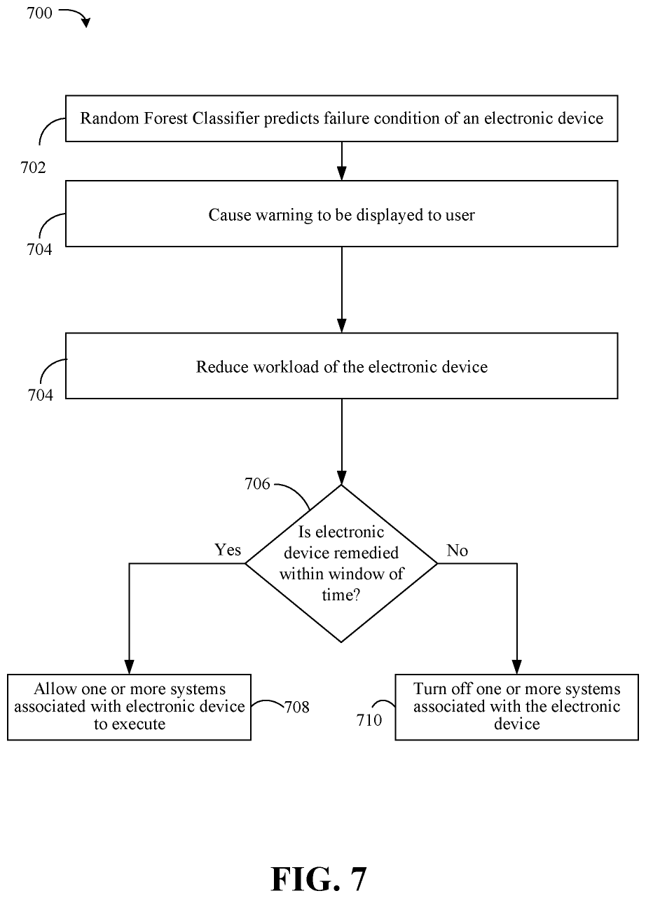

FIG. 7 shows a method 700 of executing an action based on a failure prediction of an electronic device. The method 700 may generally be implemented in conjunction with any of the embodiments described herein, for example the process 100 of FIG. 1, the system 200 of FIG. 2, the method 300 of FIG. 3, the process 400 of FIG. 4, the vehicle 500 of FIG. 5 and/or the method 600 of FIG. 6. In an embodiment, the method 700 is implemented in logic instructions (e.g., software), configurable logic, fixed-functionality hardware logic, circuitry, etc., or any combination thereof.

A Random Forest Classifier predicts a failure condition of an electronic device in illustrated processing block 702. Illustrated processing block 704 causes a warning to be displayed to the user. The warning may indicate that the electronic device may fail and suggest that the user fix the vehicle. Illustrated processing block 704 reduces a workload of the electronic device to increase the lifetime of the electronic device and avoid an immediate failure of the electronic device.

Illustrated processing block 706 determines whether the electronic device is remedied (e.g., fixed, replaced, etc.) within a window of time to avoid failure. The window of time may correspond to a maximum allowable time period for repair. That is, exceeding the window of time may result in near imminent failure of the electronic device. If not, illustrated processing block 710 may turn off one or more systems associated with the electronic device. For example, if the electronic device controls power to a display, the display may turn off to avoid damage to the display. In some embodiments, if failure of the electronic device would result in unsafe conditions (e.g., part of an autonomous driving mechanism or braking mechanism, etc.), illustrated processing block 710 may disallow movements of the vehicle. Otherwise, illustrated processing block 708 allows one or more systems associated with the electronic device to execute without restriction.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computing device comprising:
an observation data storage to store a plurality of observations associated with electronic devices associated with a vehicle; and
a training system including at least one processor and at least one memory having a set of instructions, which when executed by the at least one processor, cause the training system to:
execute an iterative training process to train an Ensemble Learning Model to predict conditions of the electronic devices, wherein the iterative training process includes:
iteratively training the Ensemble Learning Model based on different groups of the plurality of observations during different iterations, wherein the different groups of the plurality of observations are associated with different subsets of the electronic devices, and
generating an Out-of-Bag score based on whether the Ensemble Learning Model correctly predicts conditions of the electronic devices based on observations of the plurality of observations that were previously unutilized to train the Ensemble Learning Model; and
determine whether to propagate the Ensemble Learning Model to vehicles based at least in part on the Out-of-Bag score.

2. The computing device of claim 1, wherein the instructions of the at least one memory, when executed, cause the training system to:
generate a validation score for the Ensemble Learning Model based on whether the Ensemble Learning Model correctly predicts conditions of the electronic devices based on testing observations associated with the electronic devices, wherein the testing observations were unutilized during the iterative training process.

3. The computing device of claim 2, wherein the instructions of the at least one memory, when executed, cause the training system to:
determine whether to propagate the Ensemble Learning Model to the vehicles based further on the validation score.

4. The computing device of claim 3, wherein the instructions of the at least one memory, when executed, cause the training system to:
determine that the Ensemble Learning Model is to be propagated to the vehicles in response to an identification that the Out-of-Bag score and the validation score are within a predetermined amount of each other.

5. The computing device of claim 1, further comprising a network interface,
wherein the instructions of the at least one memory, when executed, cause the training system to, in response to the Out-of-Bag score matching a threshold value, cause the Ensemble Learning Model to be propagated to the vehicles via the network interface, and
further wherein the Ensemble Learning Model is a Random Forest Classifier.

6. The computing device of claim 5, wherein:
the network interface receives state data from the vehicles, wherein the state data is associated with condition detection processes executed by the vehicles based on the Ensemble Learning Model to detect conditions of electronic devices of the vehicles; and
the instructions of the at least one memory, when executed, cause the training system to:
adjust the Ensemble Learning Model based on the state data.

7. The computing device of claim 6, wherein the instructions of the at least one memory, when executed, cause the training system to:
determine, from the state data, a number of inaccurate predictions by the Ensemble Learning Model of one or more conditions of the electronic devices of the vehicles;
conduct a comparison of the number to an adjustment threshold; and
determine that the Ensemble Learning Model is to be adjusted based on the comparison.

8. At least one computer readable storage medium comprising a set of instructions, which when executed by a computing device, cause the computing device to:
execute an iterative training process to train an Ensemble Learning Model based on a plurality of observations associated with electronic devices so that the Ensemble Learning Model predicts conditions of the electronic devices, wherein the electronic devices are associated with a vehicle, further wherein the iterative training process includes:
iteratively train the Ensemble Learning Model based on different groups of the plurality of observations during different iterations, wherein the different groups of the observations are associated with different subsets of the electronic devices, and
generate an Out-of-Bag score based on whether the Ensemble Learning Model correctly predicts conditions of the electronic devices based on observations of the plurality of observations that were previously unutilized to train the Ensemble Learning Model; and
determine whether to propagate the Ensemble Learning Model to vehicles based at least in part on the Out-of-Bag score.

9. The at least one computer readable storage medium of claim 8, wherein the instructions, when executed, cause the computing device to:
generate a validation score for the Ensemble Learning Model based on whether the Ensemble Learning Model correctly predicts conditions of the electronic devices based on testing observations associated with the electronic devices, wherein the testing observations were unutilized during the iterative training process.

10. The at least one computer readable storage medium of claim 9, wherein the instructions, when executed, cause the computing device to:
determine whether to propagate the Ensemble Learning Model to the vehicles based further on the validation score.

11. The at least one computer readable storage medium of claim 10, wherein the instructions, when executed, cause the computing device to:
determine that the Ensemble Learning Model is to be propagated to the vehicles in response to an identification that the Out-of-Bag score and the validation score are within a predetermined amount of each other.

12. The at least one computer readable storage medium of claim 8, wherein the instructions, when executed, cause the computing device to:
in response to the Out-of-Bag score matching a threshold value, cause the Ensemble Learning Model to be propagated to the vehicles, and
further wherein the Ensemble Learning Model is a Random Forest Classifier.

13. The at least one computer readable storage medium of claim 12, wherein the instructions, when executed, cause the computing device to:
adjust the Random Forest Classifier based on state data, wherein the state data originates from the vehicles, further wherein the state data is associated with condition detection processes executed by the vehicles based on the Random Forest Classifier to detect conditions of electronic devices of the vehicles.

14. The at least one computer readable storage medium of claim 13, wherein the instructions, when executed, cause the computing device to:
determine, from the state data, a number of inaccurate predictions by the Ensemble Learning Model of one or more conditions of the electronic devices of the vehicles;
conduct a comparison of the number to an adjustment threshold; and
determine that the Ensemble Learning Model is to be adjusted based on the comparison.

15. A method comprising:
executing an iterative training process to train an Ensemble Learning Model based on a plurality of observations associated with electronic devices so that the Ensemble Learning Model predicts conditions of the electronic devices, wherein the electronic devices are associated with a vehicle, further wherein the iterative training process includes:
iteratively training the Ensemble Learning Model based on different groups of the plurality of observations during different iterations, wherein the different groups of the plurality of observations are associated with different subsets of the electronic devices, and
generating an Out-of-Bag score based on whether the Ensemble Learning Model correctly predicts conditions of the electronic devices based on observations of the plurality of observations that were previously unutilized to train the Ensemble Learning Model; and
determining whether to propagate the Ensemble Learning Model to vehicles based at least in part on the Out-of-Bag score.

16. The method of claim 15, further comprising:
generating a validation score for the Ensemble Learning Model based on whether the Ensemble Learning Model correctly predicts conditions of the electronic devices based on testing observations associated with the electronic devices, wherein the testing observations were unutilized during the iterative training process.

17. The method of claim 16, further comprising:
determining whether to propagate the Ensemble Learning Model to the vehicles based further on the validation score.

18. The method of claim 17, further comprising:
determining that the Ensemble Learning Model is to be propagated to the vehicles in response to an identification that the Out-of-Bag score and the validation score are within a predetermined amount of each other, and
further wherein the Ensemble Learning Model is a Random Forest Classifier.

19. The method of claim 15, further comprising:
in response to the Out-of-Bag score matching a threshold value, causing the Ensemble Learning Model to be propagated to the vehicles.

20. The method of claim 19, further comprising:
adjusting the Ensemble Learning Model based on state data, wherein the state data originates from the vehicles, further wherein the state data is associated with a condition detection process executed by the vehicles based on the Ensemble Learning Model to detect conditions of electronic devices of the vehicles.
